(19) United States
(12) Patent Application Publication
(10) Pub. No.: US 2003/0234799 A1
(43) Pub. Date: Dec. 25, 2003

(54) Method of adjusting an image size of a display apparatus in a computer system, system for the same, and medium for recording a computer program therefor

(75) Inventor: Beom-Seok Lee, Suwon City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/303,011

(22) Filed: Nov. 25, 2002

(30) Foreign Application Priority Data
Jun. 20, 2002 (KR) 2002-34628

(51) Int. Cl. G09G 5/00

(52) U.S. Cl. 345/660

(57) ABSTRACT

A method for adjusting a size of an image in a computer system that includes a video card and a display apparatus displaying an image based on a video signal received from the video card, comprising storing image displaying ratio data corresponding to a distance between the display apparatus and a user; sensing the distance between the display apparatus and the user; reading out the image displaying ratio data on the basis of the sensed distance; and adjusting the size of the image according to the read image displaying ratio data so as to transmit the adjusted video signal to the display apparatus. Thus, the present invention provides a method for adjusting a size of an image on a display apparatus, a system for the same, and a media for recording a computer program therefor, in which the size of an image is automatically adjusted according to a change of a distance between the display apparatus and a user.

### CROSS-REFERENCE TO RELATED APPLICATIONS

This application claims the benefit of Korean Application No. 2002-34628, filed Jun. 20, 2002, in the Korean Industrial Property Office, the disclosure of which is incorporated herein by reference.

### BACKGROUND OF THE INVENTION

1. Field of the Invention

The present invention relates to a computer system, and more particularly, to a computer system having a method of adjusting an image size of a display apparatus, a system for the same, and a medium for recording a computer program therefor, in which the size of the image is automatically adjusted according to a distance between the display apparatus and a user.

2. Description of the Related Art

Generally, a computer system comprises a computer main body provided with a video card, and a display apparatus processing a video signal received from the video card, and displaying an image such as a letter, a picture, etc.

Herein, the brightness, the contrast, and the resolution of the image can be adjusted, as desired by a user. The brightness and the contrast are adjusted through an adjusting button provided in the display apparatus, but on the other hand, the resolution relative to the image size is adjusted by controlling a video card through a graphic user interface (GUI) for display control.

However, in the conventional display apparatus, whenever a user desires a different image size because of a change in the distance between the display apparatus and himself/herself, the user must manually adjust the resolution of the display apparatus through the GUI.

### SUMMARY OF THE INVENTION

Accordingly, it is an object of the present invention to provide a method of adjusting an image size of a display apparatus in a computer system, a system for the same, and a medium for recording a computer program therefor, in which the size of an image is automatically adjusted according to a change of a distance between the display apparatus and a user.

Additional objects and advantages of the present invention will be set forth in part in the description that follows, and, in part, will be obvious from the description, or may be learned by practice of the present invention.

The foregoing and other objects of the present invention are achieved by providing a method of adjusting an image size in a computer system that includes a video card and a display apparatus displaying an image based on a video signal received from the video card, comprising storing image displaying ratio data corresponding to a distance between the display apparatus and a user; sensing the distance between the display apparatus and the user; reading out the image displaying ratio data on the basis of the sensed distance; and adjusting the size of the image according to the read image displaying ratio data so as to transmit the adjusted video signal to the display apparatus.

The adjusting the image size may include controlling the video card to adjust the image size according to the distance between the display apparatus and the user.

The adjusting the image size may include adjusting the video signal according to the distance between the display apparatus and the user, and transmitting the adjusted video signal to the video card.

The method may further comprise selecting an image displaying ratio setting function for personally setting an image displaying ratio in correspondence to the distance between the display apparatus and the user; and displaying an image displaying ratio setting window.

The image displaying ratio setting window may include a displaying ratio selection bar provided with a plurality of scroll bars corresponding to the distance between the display apparatus and a user so as to set up the image displaying ratio.

According to another aspect of the present invention, the above and other objects may be also achieved by providing a system for adjusting a size of an image in a computer system that includes a computer main body provided with a video card and a display apparatus displaying an image based on a video signal received from the video card, comprising a distance sensing part sensing a distance between the display apparatus and a user; an image displaying ratio data storage part storing image displaying ratio data corresponding to the distance between the display apparatus and a user; and an image size adjusting part which reads out the image displaying ratio data from the image displaying ratio data storage part according to the distance between a user and the display apparatus sensed by the distance sensor and adjusts the size of the image on the basis of the read image displaying ratio data.

The image size adjusting part may control the video card to adjust the size of the image on the basis of the read image displaying ratio data.

The image size adjusting part may adjust the video signal according to the distance between the display apparatus and the user, and transmits the adjusted video signal to the video card.

The system may further comprise an image displaying ratio setting part, wherein when the image displaying ratio setting part is selected, the image size adjusting part provides an image displaying ratio setting window for setting up an image displaying ratio personally.

The image displaying ratio setting window may include a displaying ratio selection bar provided with a plurality of scroll bars corresponding to the distance between the display apparatus and a user so as to set up the image displaying ratio.

The distance sensing part may include a sensor sensing the distance between the display apparatus and a user.

According to another aspect of the present invention, the above and other objects may be also achieved by providing a medium for recording a computer program for adjusting an image size in the computer system.

### BRIEF DESCRIPTION OF THE DRAWINGS

These and other objects and advantages of the present invention will become apparent and more readily appreciated from the following description of the embodiments, taken in conjunction with the accompany drawings of which:

FIG. 1 is a control block diagram of an image size adjusting system in a computer system according to the present invention;

FIG. 2 is a control flowchart of an image size adjusting method of a computer system according to a first embodiment of the present invention;

FIG. 3 is a control flowchart of an image size adjusting method of a computer system according to a second embodiment of the present invention;

FIG. 4 illustrates a window for setting up an image displaying ratio by a user in correspondence to a distance between the display apparatus and a user; and

FIGS. 5 and 6 illustrate the computer system according to the present invention displaying an image different in size according to the distance between the display apparatus and a user.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

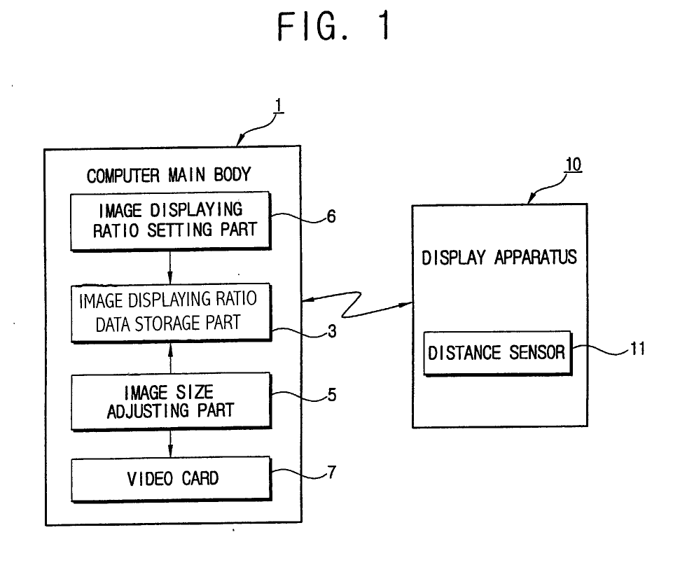

FIG. 1 is a control block diagram of an image size adjusting system of a computer system according to the present invention. As shown therein, a computer system comprises a display apparatus 10 provided with a distance sensor 11 sensing a distance between a user and the display apparatus 10, and a computer main body 1 provided with a video card 7 outputting a video signal to the display apparatus 10. The computer main body 1 includes an image displaying ratio data storage part 3 storing image displaying ratio data, an image size adjusting part 5 that reads out the image displaying ratio data from the image displaying ratio data storage part 3 according to the distance between a user and the display apparatus 10 sensed by the distance sensor 11 and adjusts a size of an image on the basis of the read image displaying ratio data, and an image displaying ratio setting part 6 for setting up an image displaying ratio by the user.

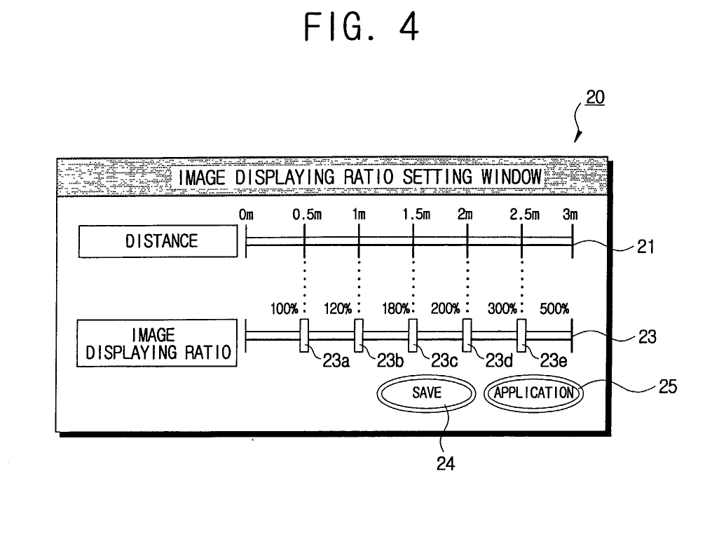

The image size adjusting part 5 is embodied in a software program based on an operating system, which adjusts the size of a video signal for an image, for example, a letter, a picture, etc., and transmits the video signal to the video card 7, or which controls the video card 7 to adjust the size of the image. This software program is automatically executed while the computer system is booted, and is resident in a RAM (random access memory), thereby automatically adjusting a size of an image when the distance between the display apparatus 10 and a user is changed. For example, when the distance between the display apparatus 10 and a user is changed from 0.5 m to 2 m, the image size adjusting part 5 enlarges the size of the image by 200% on the basis of the image displaying ratio data stored in the image displaying ratio data storage part 3. When the distance is changed from 2 m to 1 m, the image size adjusting part 5 reduces the size of the image by 100%. Herein, the software program employed as the image size adjusting part 5 provides an image displaying ratio setting window 20 (to be described later, in connection with FIG. 4) as a graphic user interface (GUI), thereby allowing a user to set up the image displaying ratio personally in correspondence to the distance between the display apparatus 10 and a user. That is, the image displaying ratio setting window 20 is served as the image displaying ratio setting part 6.

The image displaying ratio data storage part 3 previously stores the image displaying ratio data in correspondence to the distance between the display apparatus 10 and a user, and the image displaying ratio data can be personally set by a user through the image displaying ratio setting window 20. Herein, the image displaying ratio data storage part 3 is provided in a hard disk drive which keeps the image displaying ratio data therein even if the computer system is turned off.

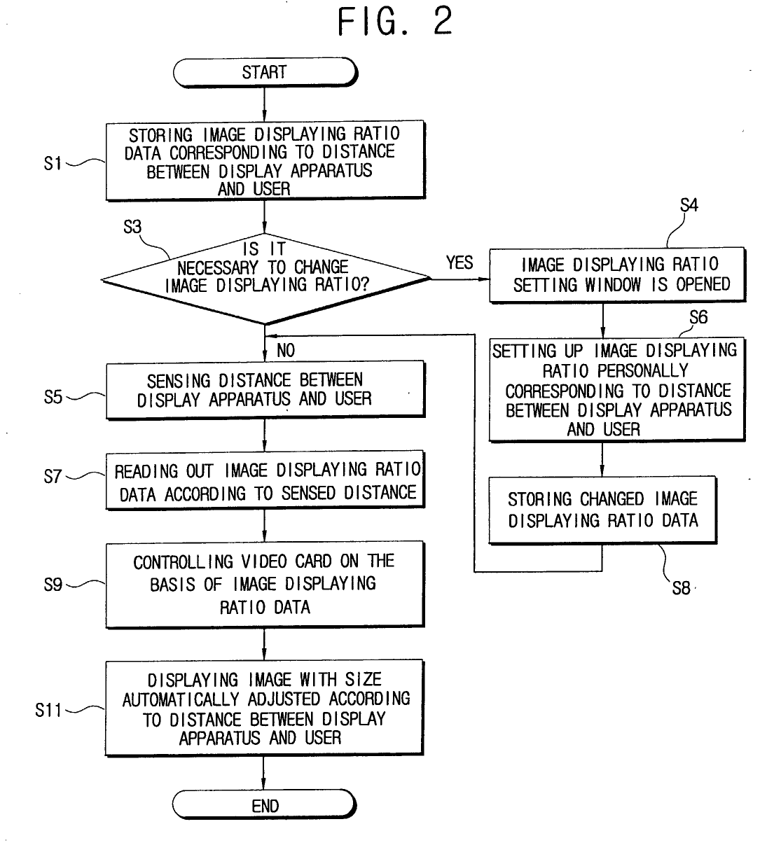

FIG. 2 is a control flowchart of an image size adjusting method of a computer system according to a first embodiment of the present invention. As shown therein, first, the image displaying ratio data corresponding to the distance between the display apparatus 10 and a user is previously stored in the image displaying ratio data storage part 3 such as the hard disk drive provided in the computer main body 1 (S1). If there is no necessity for changing the image displaying ratio in step S3, the distance sensor 11 provided in the display apparatus 10 senses a distance between the display apparatus 10 and a user in the state that the image displaying ratio data storage part 3 stores the previously stored image displaying ratio data (S5). Then, the image size adjusting part 5 receives distance data sensed by the distance sensor 11, and reads out the image displaying ratio data according to the sensed distance from the image displaying ratio data storage part 3 (S7). Thereafter, the image size adjusting part 5 controls the video card 7 on the basis of the image displaying ratio data (S9). Then, the video card 7 adjusts the size of the image and outputs it to the display apparatus 10, so that the display apparatus 10 displays an image with the size automatically adjusted according to the distance between the display apparatus 10 and a user (S11).

On the other hand, if it is necessary for a user to change the image displaying ratio personally in step S3, a user opens the image displaying ratio setting window 20 (see the discussion of FIG. 4 below) serving as the image displaying ratio setting part 6 (S4), and personally sets up the image displaying ratio corresponding to the distance between the display apparatus 10 and a user, as desired (S6). Thereafter, a user selects a save icon 24, so that changed image displaying ratio data is stored in the image displaying ratio data storage part 3 (S8). Then, the distance sensor 11 provided in the display apparatus 10 senses a distance between the display apparatus 10 and a user in the state that the image displaying ratio data storage part 3 is stored with the changed image displaying ratio data (S5). Then, the image size adjusting part 5 receives distance data sensed by the distance sensor 11, and reads out the image displaying ratio data according to the sensed distance from the image displaying ratio data storage part 3 (S7). Then, the image size adjusting part 5 controls the video card 7 on the basis of the changed image displaying ratio data (S9). Then, the video card 7 adjusts the size of the image and outputs it to the display apparatus 10, so that the display apparatus 10 displays an image with the size automatically adjusted according to the distance between the display apparatus 10 and a user, as the user wants (S11). According to the first embodiment of the present invention, the video card 7 can be controlled by a video card control program such as a text size adjusting function of a control board provided in the operating system.

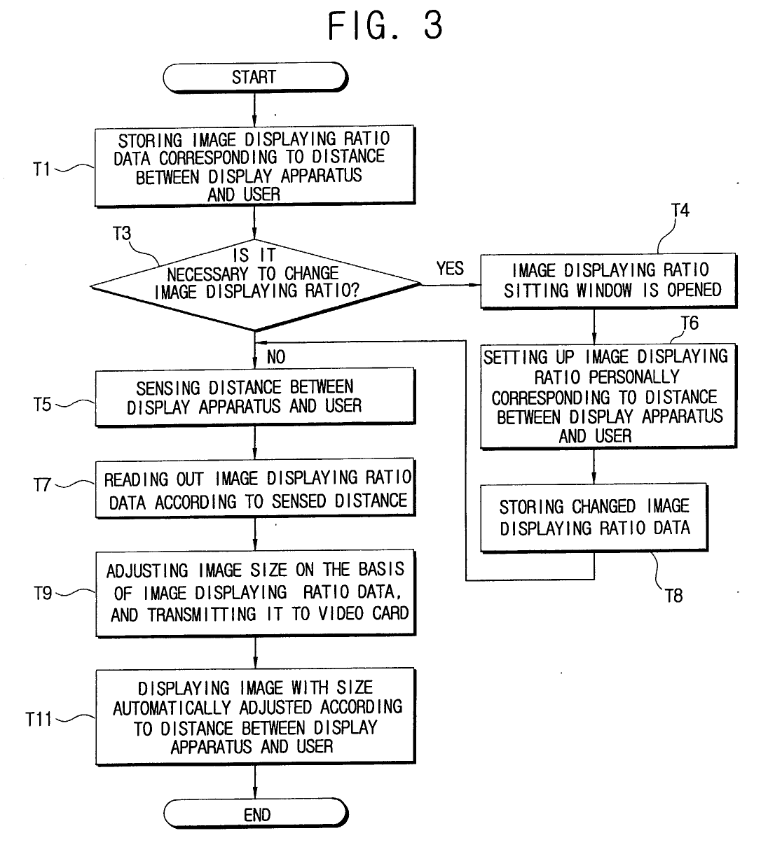

FIG. 3 is a control flowchart of an image size adjusting method of a computer system apparatus according to a second embodiment of the present invention. As shown therein, first, the image displaying ratio data corresponding to the distance between the display apparatus 10 and a user is previously stored in the image displaying ratio data storage part 3 such as the hard disk drive provided in the computer main body 1 (T1). If there is no necessity for changing the image displaying ratio (T3), the distance sensor 11 provided in the display apparatus 10 senses a distance between the display apparatus 10 and a user in the state that the image displaying ratio data storage part 3 stores the previously stored image displaying ratio data (T5). Then, the image size adjusting part 5 receives distance data sensed by the distance sensor 11, and reads out the image displaying ratio data according to the sensed distance from the image displaying ratio data storage part 3 (T7). Thereafter, the image size adjusting part 5 adjusts the size of the image on the basis of the image displaying ratio data, and transmits it to the video card 7 (T9). Then, the video card 7 outputs the video signal received from the image size adjusting part 5 to the display apparatus 10, so that the display apparatus 10 displays an image in the size automatically adjusted according to the distance between the display apparatus 10 and a user (T11).

On the other hand, if it is necessary for a user to change the image displaying ratio personally in step T3, a user opens the image displaying ratio setting window 20 (see the discussion of FIG. 4 below) serving as the image displaying ratio setting part 6 (T4), and personally sets up the image displaying ratio corresponding to the distance between the display apparatus 10 and a user, as desired (T6). Thereafter, a user selects a save icon 24, so that changed image displaying ratio data is stored in the image displaying ratio data storage part 3 (T8). Then, the distance sensor 11 provided in the display apparatus 10 senses a distance between the display apparatus 10 and a user in the state that the image displaying ratio data storage part 3 is stored with the changed image displaying ratio data (T5). Then, the image size adjusting part 5 receives a signal distance data sensed by the distance sensor 11, and reads out the image displaying ratio data according to the sensed distance from the image displaying ratio data storage part 3 (T7). Thereafter, the image size adjusting part 5 adjusts the size of the image on the basis of the changed image displaying ratio data, and transmits it to the video card 7 (T9). Then, the video card 7 outputs the video signal received from the image size adjusting part 5 to the display apparatus 10, so that the display apparatus 10 displays an image with the size automatically adjusted according to the distance between the display apparatus 10 and a user, as the user wants (T11).

FIG. 4 illustrates the image displaying ratio setting window 20 serving as the GUI, which allows a user to set up the image displaying ratio personally, as desired. As shown therein, the image displaying ratio setting window 20 has a distance indicating bar 21 indicating the distance between the display apparatus 10 and a user, a displaying ratio selection bar 23 for selecting the image displaying ratio, an application icon 25 for applying the changed image displaying ratio to the present image; and the save icon 24 for storing the changed image displaying ratio in the image displaying ratio data storage part 3.

Herein, the displaying ratio selection bar 23 is provided with a plurality of scroll bars 23a˜23e, which are moved left and right so as to set up the image displaying ratio corresponding to the distance between the display apparatus 10 and a user. Thus, a user can set up the image displaying ratio by moving respective scroll bars 23a˜23e of the distance selection bar 21.

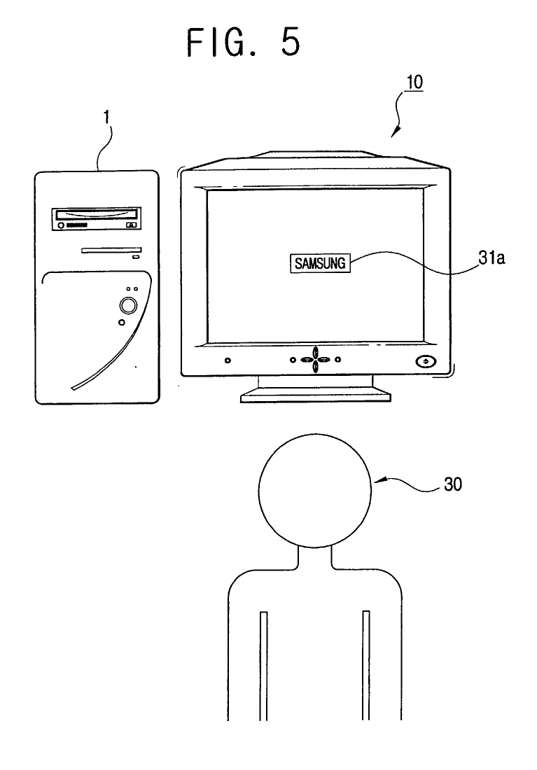

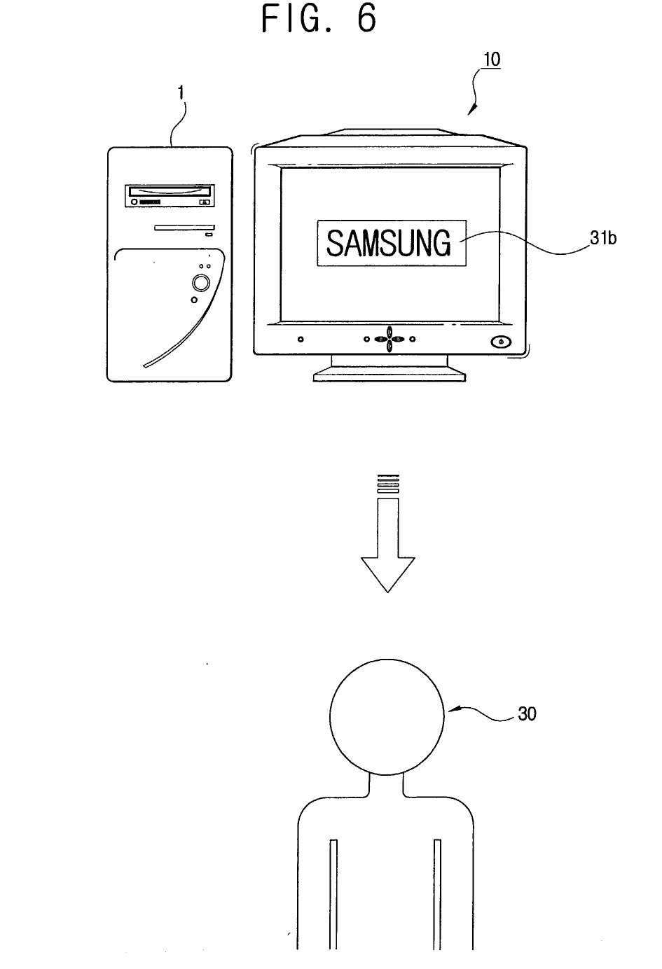

FIGS. 5 and 6 illustrate the size of an image according to the distance between the display apparatus 10 and a user. As shown therein, if the distance between the display apparatus 10 and a user 30 becomes more distant, the size of an image displayed on the display apparatus 10 is enlarged (refer to a change from 31a of FIG. 5 to 31b of FIG. 6), so that the image can be easily seen by a user. In contrast, if a user 30 moves closer to the display apparatus 10, the size of the image displayed on the display apparatus 10 is reduced (refer to a change from 31b of FIG. 6 to 31a of FIG. 5).

In the foregoing embodiments, the computer system is a desktop computer in which the computer main body 1 and the display apparatus 10 are separated from each other. However, the present invention may be applied to a portable computer in which the computer main body 1 and the display apparatus 10 are attached to each other.

In the foregoing embodiment, the image size adjusting method for the display apparatus 10 is applied to the computer system. However, the image size adjusting method may be applied to a mobile phone having a displaying device.

In the foregoing embodiment, the distance sensor 11 is provided in the display apparatus 10. However, the distance sensor may be provided in the computer main body.

With this configuration, an image such as a letter, a picture, etc. displayed on a display apparatus is automatically enlarged/reduced according to a change of a distance between the display apparatus and a user, so that the user can see the image easily regardless of the distance between the display apparatus and himself/herself.

As described above, the present invention provides a method for adjusting an image size of a display apparatus, a system for the same, and a media for recording a computer program therefor, in which the size of an image is automatically adjusted according to a change of a distance between the display apparatus and a user.

The components included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media; optical storage media, flash memory devices, electrical, optical, acoustical, or other form of propagated signals (e.g., carrier waves, infrared signals, digital signals, etc.), etc.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of adjusting a size of an image in a computer system that includes a video card and a display apparatus displaying the image based on a video signal received from the video card, comprising:
storing image displaying ratio data corresponding to a distance between the display apparatus and a user;
sensing the distance between the display apparatus and the user;
reading out the image displaying ratio data on the basis of the sensed distance; and
adjusting the size of the image according to the read image displaying ratio data so as to transmit the adjusted video signal to the display apparatus.

2. The method according to claim 1, wherein the adjusting the size of the image includes controlling the video card to adjust the size of the image according to the distance between the display apparatus and the user.

3. The method according to claim 1, wherein the adjusting the size of the image includes adjusting the video signal according to the distance between the display apparatus and the user, and transmitting the adjusted video signal to the video card.

4. The method according to claim 2, further comprising:
displaying an image displaying ratio setting window; and
selecting an image displaying ratio setting function for setting an image displaying ratio by the user using the image displaying ratio setting window in correspondence to the distance between the display apparatus and the user.

5. The method according to claim 3, further comprising:
displaying an image displaying ratio setting window; and
selecting an image displaying ratio setting function for setting an image displaying ratio by the user using the image displaying ratio setting window in correspondence to the distance between the display apparatus and the user.

6. The method according to claim 4, wherein the image displaying ratio setting window includes a displaying ratio selection bar provided with a plurality of scroll bars corresponding to the distance between the display apparatus and a user so as to set up the image displaying ratio.

7. The method according to claim 5, wherein the image displaying ratio setting window includes a displaying ratio selection bar provided with a plurality of scroll bars corresponding to the distance between the display apparatus and a user so as to set up the image displaying ratio.

8. A system for adjusting a size of an image in a computer system that includes a computer main body provided with a video card and a display apparatus displaying the image based on a video signal received from the video card, comprising:
a distance sensing part sensing a distance between the display apparatus and a user;
an image displaying ratio data storage part storing image displaying ratio data corresponding to the distance between the display apparatus and the user; and
an image size adjusting part which reads out the image displaying ratio data from the image displaying ratio data storage part according to the distance between the user and the display apparatus sensed by the distance sensor and adjusts the size of the image based upon the read image displaying ratio data.

9. The system according to claim 8, wherein the image size adjusting part controls the video card to adjust the size of the image based upon the read image displaying ratio data.

10. The system according to claim 8, wherein the image size adjusting part adjusts the video signal according to the distance between the display apparatus and the user, and transmits the adjusted video signal to the video card.

11. The system according to claim 9, further comprising an image displaying ratio setting part,
wherein when the image displaying ratio setting part is selected, the image size adjusting part provides an image displaying ratio setting window for setting up an image displaying ratio personally.

12. The system according to claim 10, further comprising an image displaying ratio setting part,
wherein when the image displaying ratio setting part is selected, the image size adjusting part provides an image displaying ratio setting window for setting up an image displaying ratio personally.

13. The system according to claim 11, wherein the image displaying ratio setting window includes a displaying ratio selection bar provided with a plurality of scroll bars corresponding to the distance between the display apparatus and the user so as to set up the image displaying ratio.

14. The system according to claim 12, wherein the image displaying ratio setting window includes a displaying ratio selection bar provided with a plurality of scroll bars corresponding to the distance between the display apparatus and the user so as to set up the image displaying ratio.

15. The system according to claim 8, wherein the distance sensing part includes a sensor sensing the distance between the display apparatus and the user.

16. The system of claim 8, wherein the computer main body is separate from the display apparatus.

17. The system of claim 8, wherein the computer main body and the display apparatus are integrally formed.

18. A medium for recording a computer program relative to the method according to claim 1, for adjusting the size of the image in the computer system.

19. A medium for recording a computer program relative to the method according to claim 2, for adjusting the size of the image in the computer system.

20. A medium for recording a computer program relative to the method according to claim 3, for adjusting the size of the image in the computer system.

21. A medium for recording a computer program relative to the method according to claim 4, for adjusting the size of the image in the computer system.

22. A medium for recording a computer program relative to the method according to claim 5, for adjusting the size of the image in the computer system.

23. A method of changing a size of an image that is displayed on a display apparatus based on a change in a distance between the display apparatus and a user, comprising:
sensing distance between a display apparatus and a user, wherein an image is displayed on the display apparatus; and
re-sizing the image based on the sensed distance and image displaying ratio data corresponding to the sensed distance.

24. The method of claim 23, further comprising:
displaying the re-sized image on the display apparatus.

25. The method of claim 23, wherein the re-sizing comprises:
adjusting the size of the image based on the sensed distance and the image displaying ratio data; and
transmitting the adjusted image to a video card for display on the display apparatus.

26. The method of claim 23, wherein the re-sizing comprises:
controlling a video card based on the sensed distance and the image displaying ratio data.

27. The method of claim 23, further comprising:
providing user controls for adjusting the image displaying ratio data.

28. The method of claim 23, further comprising:
storing the image displaying ratio data.

29. An apparatus for changing a size of an image that is displayed on a display apparatus based on a change in a distance between the display apparatus and a user, comprising:
a distance sensing unit to determine a distance between the display apparatus and the user, wherein the image is displayed on the display apparatus; and
an image size adjusting unit to adjust the size of the image based on the distance and image displaying ratio data.

30. A machine-readable medium for changing a size of an image that is displayed on a display apparatus based on a change in a distance between the display apparatus and a user, the machine-readable medium providing instructions, which, when executed by a machine, cause the machine to perform operations comprising:
sensing distance between a display apparatus and a user, wherein an image is displayed on the display apparatus; and
re-sizing the image based on the sensed distance and image displaying ratio data corresponding to the sensed distance.

31. The machine-readable medium of claim 30, wherein the instructions cause the machine to perform operations further comprising:
displaying the re-sized image on the display apparatus.

32. The machine-readable medium of claim 30, wherein the re-sizing comprises:
adjusting the size of the image based on the sensed distance and the image displaying ratio data; and
transmitting the adjusted image to a video card for display on the display apparatus.

33. The machine-readable medium of claim 30, wherein the re-sizing comprises:
controlling a video card based on the sensed distance and the image displaying ratio data.

34. The machine-readable medium of claim 30, wherein the instructions cause the machine to perform operations further comprising:
providing user controls for adjusting the image displaying ratio data.

35. The machine-readable medium of claim 30, wherein the instructions cause the machine to perform operations further comprising:
storing the image displaying ratio data.
